(19) United States
(12) Patent Application Publication
(10) Pub. No.: US 2011/0267434 A1
(43) Pub. Date: Nov. 3, 2011

(54) CAMERA DEVICE, ARRANGEMENT AND SYSTEM

(75) Inventor: Hideki ANDO, Tokyo (JP)

(73) Assignee: Sony Corporation, Tokyo (JP)

(21) Appl. No.: 13/081,893

(22) Filed: Apr. 7, 2011

(30) Foreign Application Priority Data
Apr. 30, 2010 (GB) 1007249.4

(51) Int. Cl. H04N 13/02; H04N 13/04; H04N 5/232

(52) U.S. Cl. 348/47; 348/345; 348/51; 348/E05.045; 348/E13.074; 348/E13.026

(57) ABSTRACT

There is described a camera device for capturing the image of an object, the camera device comprising: a lens arrangement for focusing the image of the object onto an image capture device for capturing the image of the object; and a movable element operable to move the focussed light relative to the image capture device in one direction, wherein the amount by which the element is movable is determined by the amount of adjustment required to the position of the image on the image capture device in said direction, wherein the lens arrangement comprises at least one lens having an image circle whose size is dependent upon the maximum displacement of the movable element in said one direction.

### BACKGROUND OF THE INVENTION

1. Field of the Invention

The present invention relates to a camera device, arrangement and system.

2. Description of the Prior Art

When shooting footage to be displayed as a stereoscopic image on a screen, traditionally, two cameras which are horizontally displaced from one another are used. FIG. 1A shows a typical prior art arrangement. As is seen in FIG. 1A, a right camera 105 and a left camera 110 are horizontally displaced from one another. Both the right camera 105 and the left camera 110 are focussing on object 100. In other words, the optical axes of both cameras converge on object 100. In order for the optical axes to converge on object 100, both the right camera 105 and the left camera 110 are angled to slightly face one another. This is called “toe-in”.

FIG. 1B shows the images captured by the right camera 105 and the left camera 110. Specifically, image 115 shows the image captured by the left camera 110 and image 120 shows the image captured by the right camera 105. Therefore, in the captured object 100′ and the captured object 100″, a common point 130 is shown. This common point 130 is also highlighted on object 100.

Both the right camera 105 and the left camera 110 are capturing the same object 100. The cameras should be horizontally displaced from one another with the vertical disparity kept to a minimum. This is because, although the viewer can tolerate a small amount of vertical disparity, a small vertical disparity can cause complications with disparity extraction. Therefore, all horizontal lines on the object 100 should be horizontal in the captured objects 100′ and 100″. However, as is shown by lines 125 in captured image 115, the edges of the captured object 100′ which should be horizontal are slightly inclined across the captured image 115. This inclined epipolar line complicates disparity extraction.

Also, as the image captured by the right camera 105 should, where possible, be only horizontally displaced from the image captured by the left camera 110, common point 130 should be located along the same horizontal line in the captured images. However, from FIG. 1B, it is apparent that the common point 130 in the two captured images is vertically displaced by d pixels. This vertical displacement (sometimes referred to as “vertical parallax”) results in an uncomfortable three dimensional perception for the viewer when watching the resulting stereoscopic image.

In FIG. 1C a different camera arrangement is shown. In FIG. 1C, the right camera 150 and the left camera 155 are aligned to be parallel with one another. In other words, the optical axes of the cameras are substantially parallel to one another. This arrangement is used when the optical axes of the right camera 150 and the left camera 155 are not to converge. The images captured by the right camera 150 and the left camera 155 are shown in FIG. 1D. Specifically, the image captured by the left camera 155 is image 165 and the image captured by the right camera 150 is image 160.

From FIG. 1D, the object 100′ in captured image 165 is located to the right of the centre line 170 of captured image 165. Similarly, the object 100″ in captured image 160 is located to the left of centre line 170 of captured image 160. Specifically, the centre of the object 100′ and 100″ is displaced from the centre of the respective images by a distance d_{R} and d_{L} respectively. Although this arrangement removes vertical parallax, and ensures the epipolar line is horizontal, there are other problems associated with this arrangement.

Specifically, because the optical axes of the cameras do not converge, it is not possible to obtain the required disparity between the two images easily. It may be possible to reduce the effect of this phenomenon by adjusting the horizontal position of the left image relative to the right image in post-processing. However, this does not make most efficient use of the horizontal pixels in the respective captured images of the object. It is an aim of the present invention to address the above problems.

### SUMMARY OF THE INVENTION

According to one aspect of the present invention, there is provided a camera device for capturing an image of an object, the camera device comprising: a lens arrangement for focusing the image of the object onto an image capture device for capturing the image of the object; wherein the size of the image capture device in one direction is related to the amount of adjustment required to the position of the image on the image capture device in said direction.

The direction may be the horizontal direction.

There may be also provided a camera arrangement comprising two camera devices according to an embodiment of the present invention having parallel optical axes and being separated by a predetermined amount.

The camera arrangement may be connectable to a processing device, wherein the processing device is operable to adjust the position of the one or both captured images relative to one another.

The position of one or both images may be adjusted such that when the images captured by the respective camera devices are viewed stereoscopically, the disparity between the viewed objects is a predetermined distance.

When the position of both images is adjusted, such adjustment may be performed in synchronism.

According to another aspect, there is provided a camera device for capturing the image of an object, the camera device comprising: a lens arrangement for focusing the image of the object onto an image capture device for capturing the image of the object; and a movable element operable to move the focussed light relative to the image capture device in one direction, wherein the amount by which the element is movable is determined by the amount of adjustment required to the position of the image on the image capture device in said direction.

The movable element may be a further movable lens forming part of the lens arrangement or is operable to move the image capture device.

The direction may be the horizontal direction.

The lens arrangement may comprise at least one lens having an image circle whose size is dependent upon the maximum displacement of the movable element in said one direction.

There may be also provided a camera arrangement comprising two camera devices according to any one of the embodiments having parallel optical axes and being separated by a predetermined amount.

The movable lens may be configured to adjust the optical path of the light such that when the images captured by the respective camera devices are viewed stereoscopically, the disparity between the viewed objects is a predetermined distance.

There may be provided a camera system comprising a camera arrangement according to an embodiment of the invention which is connectable to a processing device, wherein the processing device may be operable to adjust the position of the one or both captured images relative to one another.

When the position of both captured images is adjusted, the processing device may be operable to adjust the position of both images in synchronism with one another.

In another aspect, there is provided a camera device for capturing the image of an object, the camera device comprising: a lens arrangement for focusing the image of the object onto an image capture device for capturing the image of the object; and an anamorphic lens located within the optical axis of the camera device, wherein the amount of anamorphisation provided by the anamorphic lens in one direction is determined in accordance with the amount of adjustment required to the position of the image on the image capture device in said direction.

The direction may be the horizontal direction.

There may be provided a camera arrangement comprising two camera devices according to an embodiment of the invention having parallel optical axes and being separated by a predetermined amount.

There may be provided a camera system comprising a camera arrangement according to an embodiment of the invention connectable to a processor, wherein the processor is operable to adjust the position of the object such that when the images captured by the respective camera devices are viewed stereoscopically, the disparity between the viewed objects is a predetermined distance.

The processor may be further operable to expand the anamorphised captured image in said direction.

According to another aspect, there is provided a camera system comprising a first camera device and a second camera device having parallel optical axes and being separated by a predetermined amount and a processing device, wherein the processing device is operable to extract an area from within each captured image, the area comprising the object and a surround, wherein the area in each captured image is selected such that when both areas are stereoscopically viewed, the disparity between the two objects in the areas is a predetermined amount.

The processing device may be further operable to expand the extracted area to the size of the original captured image.

There may also be provided a camera device according to any one of the embodiments comprising an output terminal operable to output the amount of movement of the element to a further device.

According to another aspect, there is provided a method of capturing an image of an object, comprising: providing a lens arrangement for focusing the image of the object onto an image capture device for capturing the image of the object; wherein the size of the image capture device in one direction is related to the amount of adjustment required to the position of the image on the image capture device in said direction.

The direction may be the horizontal direction.

The method may further comprise capturing two images having parallel optical axes and being separated by a predetermined amount.

The method may further comprise adjusting the position of the one or both captured images relative to one another.

The position of one or both images may be adjusted such that when the images are viewed stereoscopically, the disparity between the viewed objects is a predetermined distance.

When the position of both images is adjusted, such adjustment may be performed in synchronism.

The method may comprise providing a lens arrangement for focusing the image of the object onto an image capture device for capturing the image of the object; and moving the focussed light relative to the image capture device in one direction, wherein the amount by which the element is movable is determined by the amount of adjustment required to the position of the image on the image capture device in said direction.

Either a lens forming part of the lens arrangement or the image capture device may be movable.

The direction may be the horizontal direction.

The lens arrangement may comprise at least one lens having an image circle whose size is dependent upon the maximum displacement of the movable element in said one direction.

The method may comprise capturing two images having parallel optical axes and separating said images by a predetermined amount.

The method may comprise adjusting the optical path of the light such that when the captured images are viewed stereoscopically, the disparity between the viewed objects is a predetermined distance.

The method may comprise adjusting the position of the one or both captured images relative to one another.

The method may comprise adjusting the position of both images in synchronism with one another.

According to another aspect, there is provided a method for capturing the image of an object, comprising: providing a lens arrangement for focusing the image of the object onto an image capture device for capturing the image of the object; and an anamorphic lens located within the optical axis of the camera device, wherein the amount of anamorphisation provided by the anamorphic lens in one direction is determined in accordance with the amount of adjustment required to the position of the image on the image capture device in said direction.

The direction may be the horizontal direction.

The method may comprise capturing two images of the object, the images having parallel optical axes and being separated by a predetermined amount.

The method may comprise adjusting the position of the object such that when the images are viewed stereoscopically, the disparity between the viewed objects is a predetermined distance.

The method may comprise expanding the anamorphised captured image in said direction.

The method may comprise extract an area from within each captured image, the area comprising the object and a surround, wherein the area in each captured image is selected such that when both areas are stereoscopically viewed, the disparity between the two objects in the areas is a predetermined amount.

The method may comprise expanding the extracted area to the size of the original captured image.

According to another aspect, there is provided a computer program containing computer readable instructions which, when loaded onto a computer, configure the computer to perform a method according to any one of the embodiments of the invention. A computer program configured to store the computer program therein or thereon is also provided.

### BRIEF DESCRIPTION OF THE DRAWINGS

The above and other objects, features and advantages of the invention will be apparent from the following detailed description of illustrative embodiments which is to be read in connection with the accompanying drawings, in which:

FIGS. 1A-1D show prior art camera arrangements;

FIG. 2 shows a schematic diagram of a camera;

FIGS. 3A and 3B shows one camera arrangement according to an embodiment of the present invention;

FIGS. 4A and 4B show a camera arrangement according to another embodiment of the present invention;

FIGS. 5A and 5B show a camera arrangement according to another embodiment of the present invention;

FIGS. 6A and 6B show a camera arrangement according to another embodiment of the present invention;

FIG. 7 shows a camera system according to one embodiment of the present invention; and

FIG. 8 shows a graphical user interface used in a processing device shown in FIG. 7.

### DESCRIPTION OF THE PREFERRED EMBODIMENTS

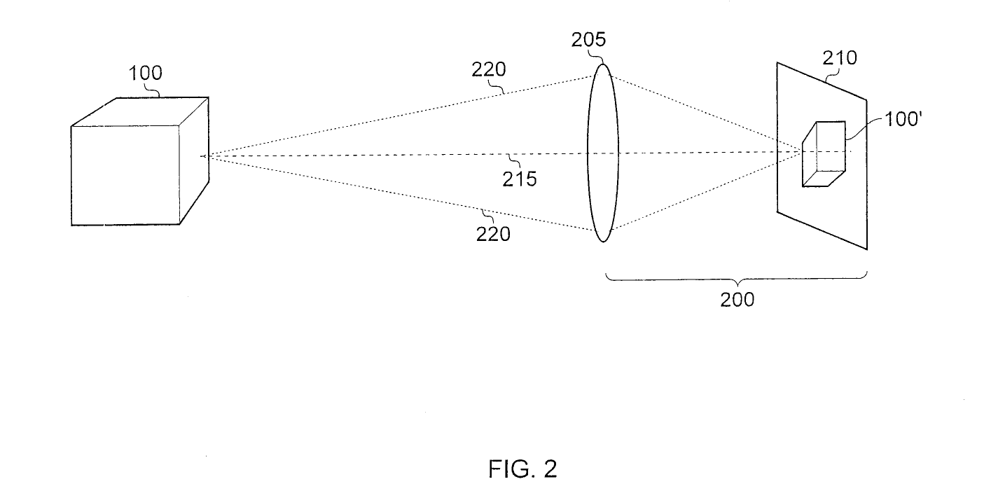

In FIG. 2, a camera device 200 which captures an image of the object 100 is shown. The camera device 200 includes a lens arrangement 205 through which light 220 is passed. The lens arrangement 205 may include one or more lenses. The light passing through the lens arrangement 205 is focussed on an image capture device 210 such as a charge coupled device array (CCD) or any other type of image capture device 210 such as Complementary Metal Oxide Semiconductor (CMOS). The captured version of object 100′ is shown on the image capture device 210. Additionally, the camera device 200 has an optical axis 215 which passes through the centre of the lens arrangement 205. This camera device 200 forms the basis of embodiments of the present invention as will be explained. Specifically, the lens arrangement 205 and/or the image capture device 210 may differ in embodiments of the present invention.

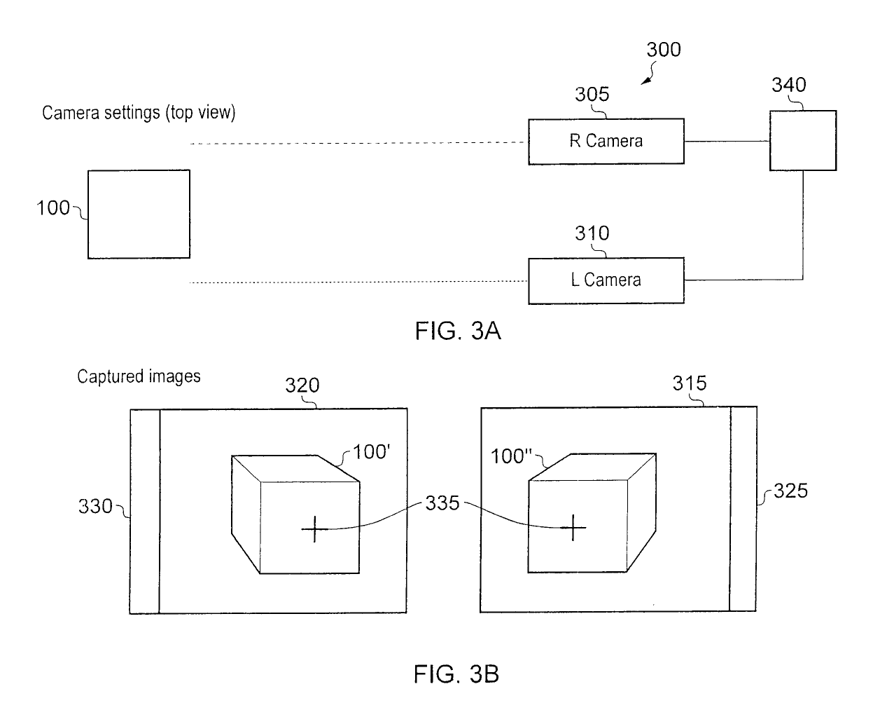

Referring to FIG. 3A, a parallel arrangement 300 of a left camera device 310 and a right camera device 305 is shown. In other words, the left camera device 310 and the right camera device 305 are arranged substantially in parallel to one another and are both used to capture an image of object 100. The image captured by the left camera device 310 and the right camera device 305 is shown in FIG. 3B. Specifically, the image captured by the left camera device 310 is shown in image 320 and the image captured by the right camera device 305 is shown in image 315. The image 320 captured by the left camera device 310 has object 100′ located therein and the image 315 captured by the right camera device 305 has object 100″ located therein. The objects 100′ and 100″ have a centre point 335. As can be seen, the image 320 captured by the left camera device 310 includes a first supplemental area 330 and the image 315 captured by the right camera device 305 includes a second supplemental area 325. The first supplemental area 330 and the second supplemental area 325 are produced because the image capture device 210 in each of the left camera 310 and the right camera 305 has a wide aspect ratio compared with conventional image capture devices. In other words, the first supplemental area 330 and the second supplemental area 325 are areas created by the additional width in the aspect ratio of the image capture devices located in the left camera device 310 and the right camera device 305 respectively. In embodiments of the invention, the first supplemental area 330 and the second supplemental area 325 increase the horizontal size of the image capture device 210 used in the first embodiment by, for example, 15%. So, a typical conventional image capture device 210 used to capture High Definition images has 1920×1080 pixels. However, in this embodiment where the horizontal size is increased by 15%, the image capture device 210 in each of the left camera device 310 and the right camera device 305 has 2208×1080 pixels.

It is noted here that although the first supplemental area 330 and the second supplemental area 325 increases the horizontal size of the image capture device 210 by, for example 15%, the invention is not so limited. Indeed, in embodiments, the size of the supplemental area depends on one or more of the interocular distance, the distance between the camera and the subject, the angle of the field of view of the camera and the position in which the captured subject should be placed within the image.

As noted above, one problem with the conventional arrangement of parallel cameras is that the images of the captured object may not have an appropriate amount of disparity. This offset in the conventional arrangement means that the correct disparity is not produced when viewing the left image 320 and the right image 315 stereoscopically. However, by providing the first and second supplemental areas 330 and 325 the additional width allows the position of the object captured in the respective image to be adjusted to ensure that the correct disparity is provided between the images when viewed together. In other words, it is possible to crop and/or adjust the position of the images 320 and 315 after the images have been captured such that the disparity between object 100′ and 100″ is correct when viewing the images 320 and 315 stereoscopically. The cropping and/or adjustment will be carried out by a processor 340 with an appropriate suite of software loaded thereon. The images may be fed to the processor 340 by a wired or wireless connection. Alternatively, the images may be fed to the processor using a separate storage medium.

The first supplemental area 330 and the second supplemental area 325 may be the same size. Alternatively, they may be different sizes depending on the application of the left and right camera devices. Also, although the first supplemental area 330 and the second supplemental area 325 provide an extra wide aspect ratio, the supplemental area may be applied in the vertical direction in addition to, or instead of, the extra wide aspect ratio.

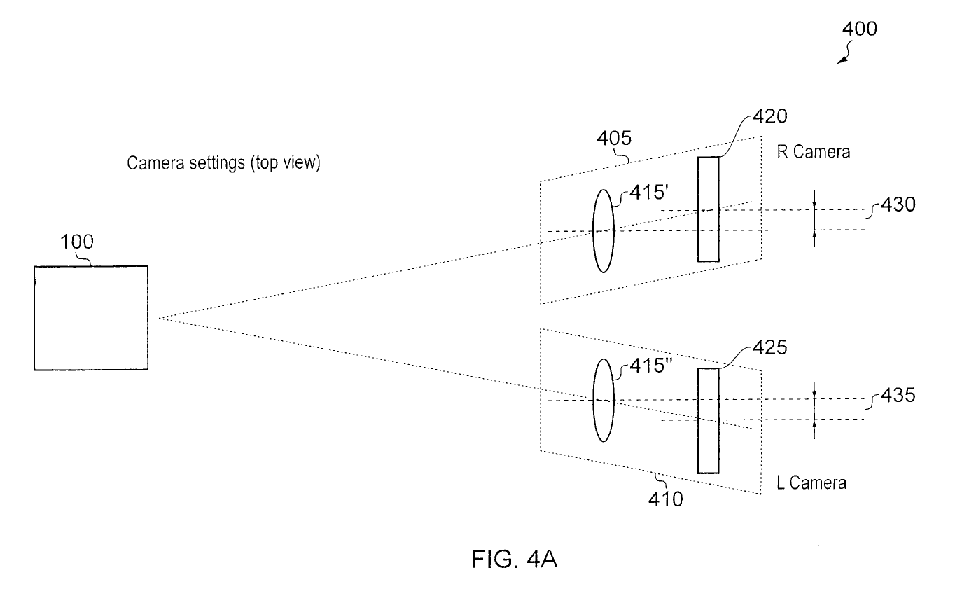

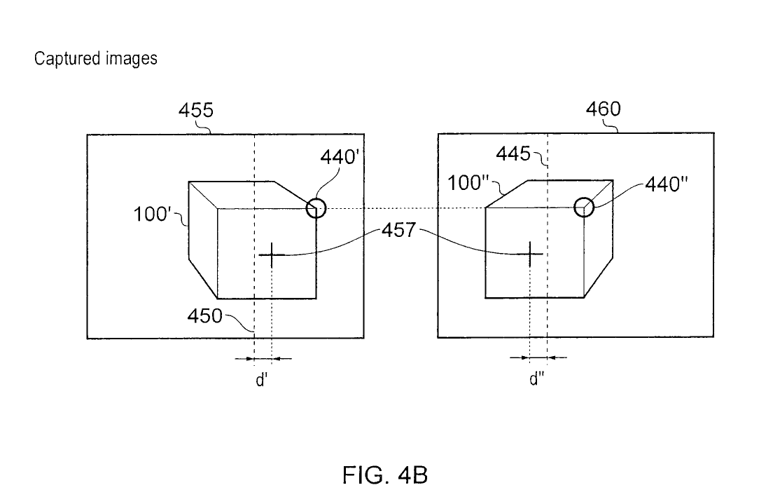

FIG. 4A shows another embodiment of the present invention. In this embodiment, a camera arrangement 400 is shown. This camera arrangement 400 includes a left camera device 410 and a right camera device 405. The left camera device 410 and the right camera device 405 are in a parallel arrangement. However, unlike the embodiment discussed in relation to FIGS. 3A and 3B, the image capture device 420 in the right camera device 405 and the image capture device 425 in the left camera device 410 do not necessarily provide an extra wide aspect ratio. However, the invention is not so limited and one or both of the image capture devices 420 and 425 may provide the extra wide aspect ratio.

There is provided in the lens arrangement of the right camera device 405 a lens 415′. Also, there is provided in the lens arrangement of the left camera device 410 a lens 415″. The lenses 415′ and 415″ form part of the lens arrangement required to focus the light on the image capture devices. Both lenses 415′ and 415″ are horizontally displaced from the centre of the image device and bend the light impinging on the lens towards the optical axis of the imager device. The amount by which the further lenses are horizontally displaced is determined by the amount of horizontal displacement required to be applied to the subject. Therefore, by horizontally displacing the lenses 415′ and 415″ relative to the centre of the image capture devices 420 and 425 respectively, the horizontal position of the captured object is displaced by a similar amount. From FIG. 4A, for example, it is seen that the optical axis of lens 415′ in the right camera device 405 is displaced by an amount 430 relative to the centre of the image capture device 420. Similarly, the optical axis of lens 415″ in the left camera device 410 is displaced by an amount 435 relative to the centre of the image capture device 425.

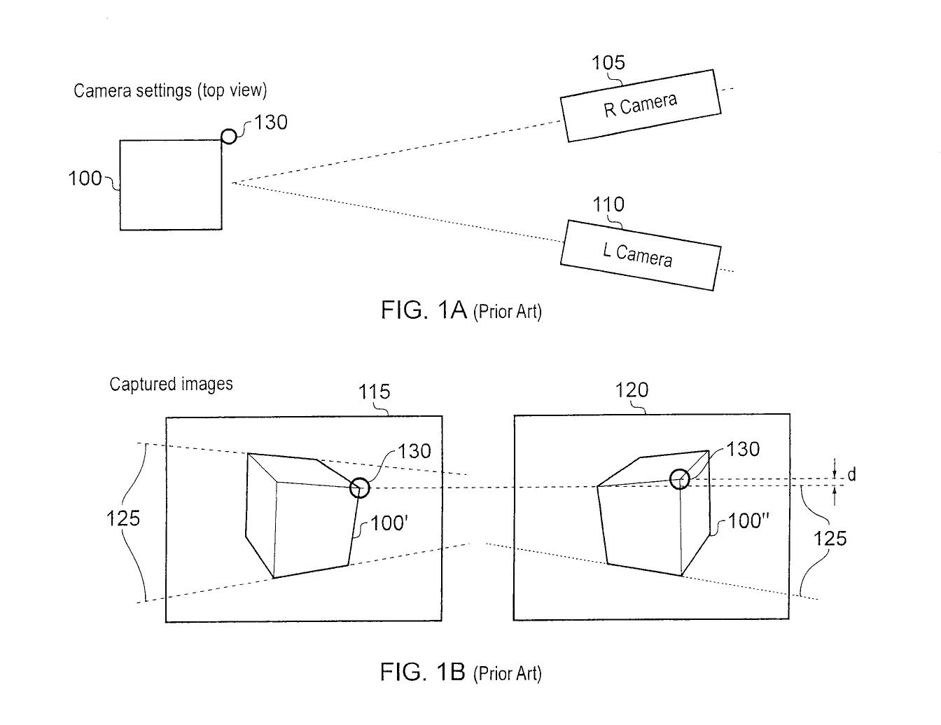

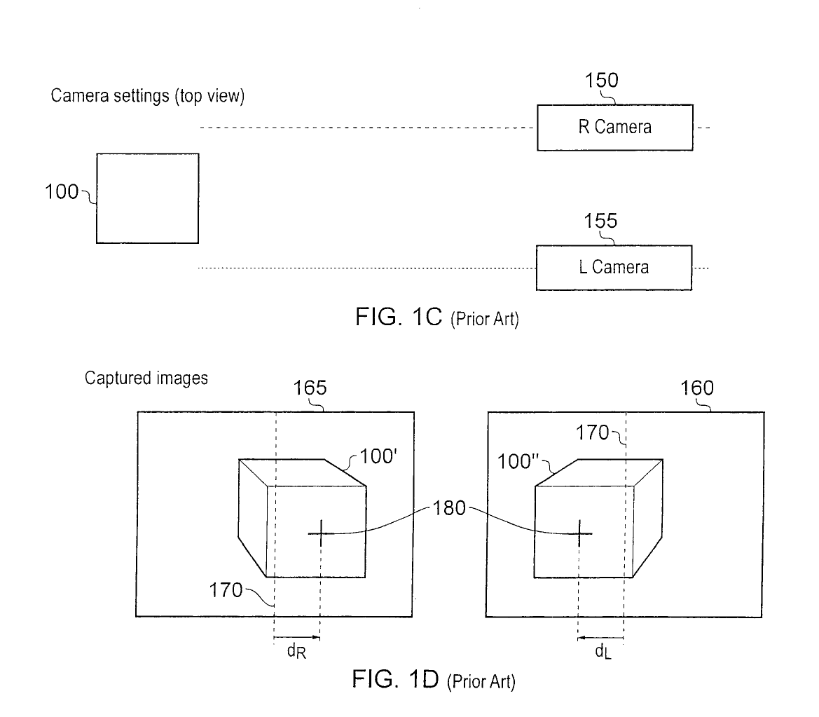

Referring to FIG. 4B, image 455 is captured by the left camera device 410 and image 460 is captured by the right camera device 405. As can be seen from FIG. 4B, the centre of image 455 is shown by line 450 and the centre of image 460 is shown by line 445. With the camera arrangement 400, the centre 457 of object 100′ in image 455 is located a distance d′ from line 450 and the centre 457 of object 100″ in image 460 is located a distance d″ from line 445. By comparing FIG. 4B with FIG. 1D, it is apparent that the distance d′ in FIG. 4B is smaller than distance d_{R} in FIG. 1D. Similarly, it is apparent that the distance d″ is smaller than distance d_{L}, in FIG. 1D. Therefore, by including the lenses 415′ and 415″ as in the embodiment of FIG. 4A, the captured object is located closer to the centre of the captured image. Moreover, as will be apparent from points 440′ and 440″ in FIG. 4B, the horizontal epipolar lines are maintained. It should be noted here that the examples set out in FIGS. 4A and 4B discuss moving the captured object towards the centre of the image capturing devices 420 and 425. However, the invention is not so limited. By horizontally displacing the further lenses relative to the respective image capture device, the object of interest can be located anywhere within the cameras field of view allowing the disparity between the captured objects to be manipulated. This allows a positive parallax to be achieved using a parallel camera arrangement.

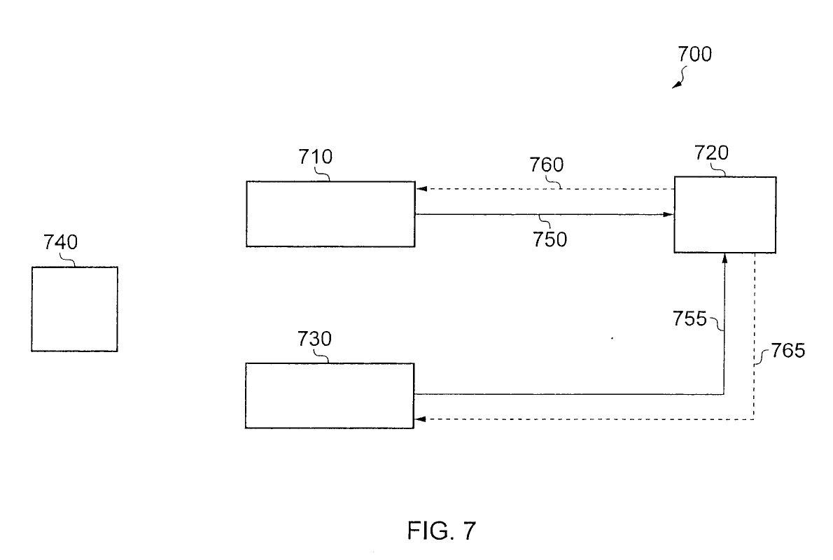

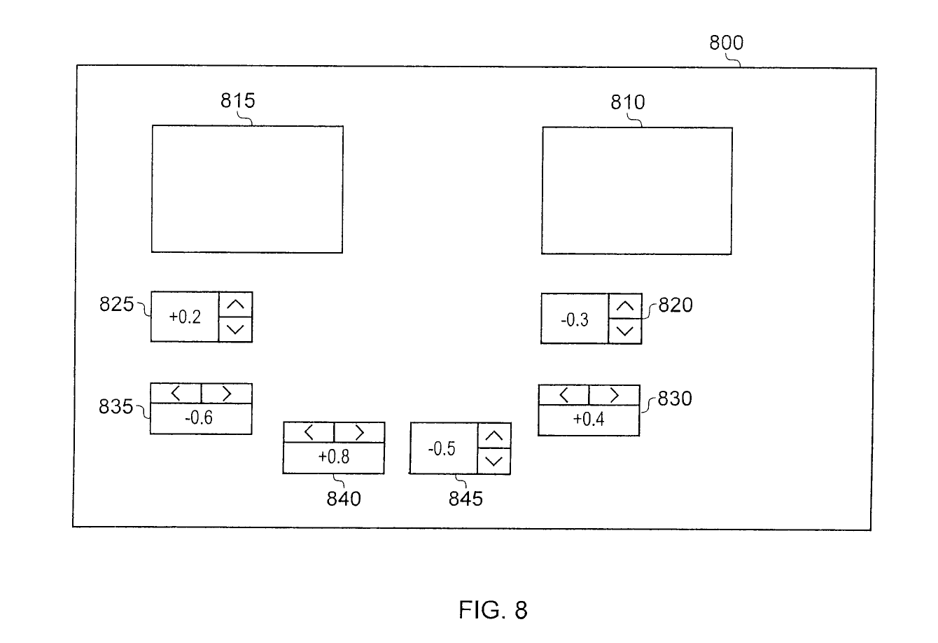

There are a number of methods available for horizontally displacing lens 415′ and 415″ relative to the respective image capturing devices 420 and 425. In one embodiment, each further lens 415′ and 415″ is connected to a separate stepper motor. Each stepper motor provides very accurate control of the horizontal displacement of the lenses 415′ and 415″. The stepper motor may controlled by the user of the camera arrangement 400 or as will be explained in FIGS. 7 and 8, by an external processor. Each further lens 415′ and 415″ may be adjusted independently to one another, or may be adjusted in synchronisation with one another. In other words, it may be advantageous to apply the same horizontal displacement to the lenses because this results in an improved 3 dimensional effect when viewed stereoscopically. This advantage is achieved because the same horizontal displacement is applied to each image and so the appropriate disparity is achieved between the two images when viewed together. Additionally, or alternatively, the image capture device in each respective camera may be adjusted along with or instead of the further lenses 415′ and 415″. Again, the movement of the image capture device in each respective camera may be controlled using a stepper motor or any other known method of moving an image capture device, which may be controlled by the user or by an external processor.

Further, as the left and right camera device 410 and 405 include the horizontally displacing further lens 415′ and 415″ which moves from the optical axis of the respective camera device, it is advantageous for at least one of the other lenses in the camera device to have an image circle wider than is conventional. Specifically, it is advantageous to have an image circle that is at least as wide as the maximum movement of the displacing lens 415′ and 415″. This improves the resolution of the captured image.

It should be noted here that moving the lens relative to the image capture device is only one method by which the optical path impinging on the respective camera device can be adjusted. Other mechanisms such as having a different lens shape or configuration may be used instead or in combination with moving the lens. Further, the further lenses can be moved in any direction as required and the invention is not limited to just horizontal movement.

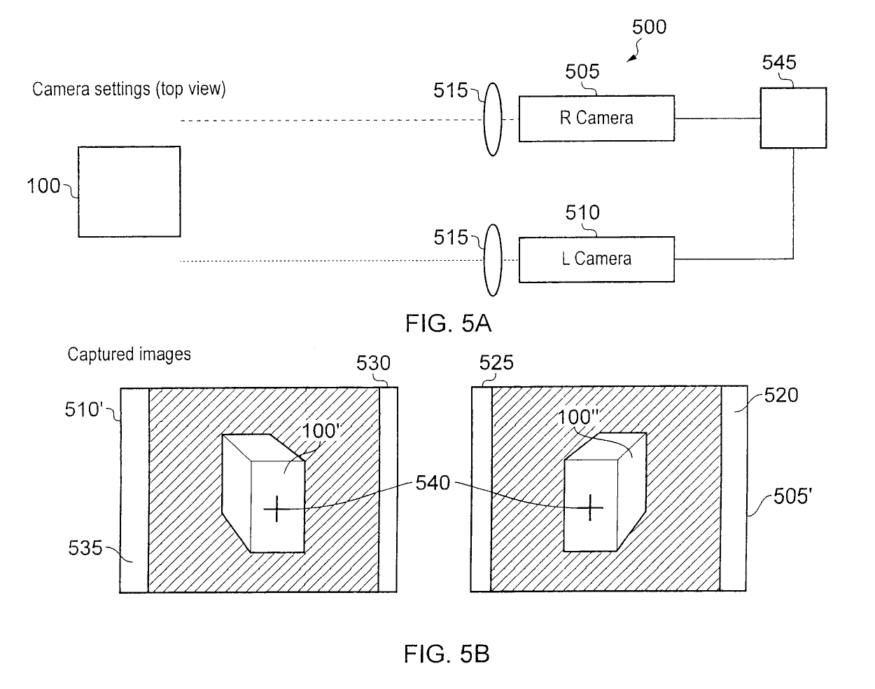

Referring to FIG. 5A, a parallel arrangement 500 of a left camera device 510 and a right camera device 505 according to another embodiment of the present invention is shown. This camera arrangement 500 is used to capture an image of object 100. In front of the left camera device 510 is an anamorphic lens 515. Similarly, in front of the right camera device 505 is another anamorphic lens 515. The optical axis of each anamorphic lens 515 is coincident with the optical axis of the respective camera devices. As will become apparent later, the amount of anamorphisation (or in the specific embodiment horizontal “squeeze”) provided by each anamorphic lens 515 will be determined by a director. However, the resulting anamorphisation to achieve the effect required by the director will depend on a number of factors. The amount of anamorphisation may depend on the amount of distance between the optical axis of the camera device and the object to be captured, the angle of the field of view of the camera, the camera setting and the distance of the subject from the camera. Other factors include the screen size onto which the stereoscopic image is to be displayed. In other words, the amount of anamorphisation depends on the amount of adjustment required to the position of the image to achieve the effect desired by the director.

Referring to FIG. 5B, the images captured by the left camera device 510 and the right camera device 505 are shown. Specifically, image 510′ shows the image captured by the left camera device 510′ and image 505′ shows the image captured by the right camera device 505.

In the image 510′ captured by the left camera 510, there is a first area 535 and a second area 530. In the embodiment explained with reference to FIGS. 2A and 2B, the supplemental area was provided by the image capture device having a wider aspect ratio than normal. However, in this embodiment, the image capture device in each camera is conventional. Instead, in this embodiment, the first area 535 and the second area 530 are provided because anamorphic lens 515 “squeezes” the captured image of the object 100′. By “squeezing” the captured object 100′ in the horizontal direction, the horizontal size of the captured object on the image capture device is reduced. This means that an area of the image capture device is then unused. The area of this unused area is equivalent to the combined area of the first area 535 and the second area 530.

Following image capture, the “squeezed” object 100′ is then positioned using post-capture processing to provide the required disparity. In this case, the post-capture processing is provided by processor 545. In this embodiment, the centre 540 of the squeezed object 100′ is positioned in the centre of the captured image 510′. However, the invention is not so limited. Indeed, by creating the areas 530 and 535, the captured object 100′ can be positioned anywhere in the image to provide an appropriate disparity between the two images when viewed stereoscopically.

In order to counter the “squeezed” effect of the captured image 510′, further post processing is used to horizontally stretch the active image area (which is the area highlighted in captured image 510′ by the hatched lines) to fill the entire captured image area. This means that the captured object 100′ is positioned depending on the required disparity and is then stretched to counter the “squeeze” effect. The post-processing which allows the positioning of the “squeezed” object 100′ and the stretching of the active image area can be performed by any editing suite on the processor 545 such as the Quantel Sid product.

Similarly, in the image 505′ captured by the right camera 505, there is a third area 525 and a fourth area 520. In this embodiment, the third area 525 and the fourth area 520 are provided because anamorphic lens 515 “squeezes” the captured image of the object 100″. By “squeezing” the captured object 100″ in the horizontal direction, the horizontal size of the captured object on the image capture device is reduced. This means that an area of the image capture device is then unused. The area of this unused area is equivalent to the combined area of the third area 525 and the fourth area 520.

Following image capture, the “squeezed” object 100″ is then positioned using post-capture processing to provide the required disparity. Although the specific example shows the centre 540 of the squeezed object 100″ being positioned in the centre of the captured image 505′, the invention is not so limited. The captured object 100″ can be positioned anywhere in the image to provide an appropriate disparity between the two images when viewed stereoscopically.

In order to counter the “squeezed” effect of the captured image 505′, further post processing is used to horizontally stretch the active image area (which is the area highlighted in captured image 505′ by the hatched lines) to fill the entire captured image area. This means that the captured object 100″ is positioned depending on the required disparity and is then stretched to counter the “squeeze” effect. The post-processing which allows the positioning of the “squeezed” object 100″ and the stretching of the active image area can be performed by any editing suite such as the Quantel Sid product.

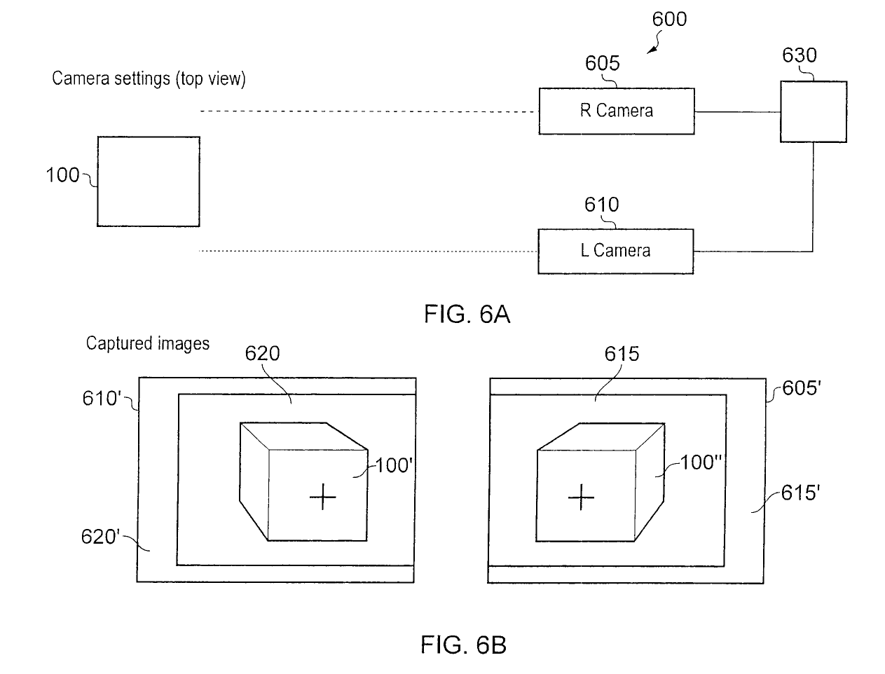

Referring to FIG. 6A, another parallel camera arrangement according to an embodiment is described. In this camera arrangement 600, a left camera device 610 and a right camera device 605 are used to capture an image of the object 100.

Referring to FIG. 6B, an image 610′ captured by the left camera device 610 and processed using a method according to an embodiment of the invention is shown. Further, an image 605′ captured by the right camera device 605 and processed using the method according to an embodiment is shown. This processing may be carried out in each camera device. Alternatively, the processing may be carried out in a separate processor 630 as shown using an appropriate editing suite.

After capture of the image, the active area of the image is selected. The active area may be selected by a user. Alternatively, the active area may be automatically selected. In the case of the active area being automatically selected, object detection is used to detect the or each object in the captured image. A boundary surrounding the detected object is then generated. This boundary may be 100 pixels surrounding the object, although any number of pixels may be selected and may depend on a number of factors such as the size of the detected object. The boundary forms the active area.

In image 610′, the active area 620 is shown. After the boundary is defined, the non-active area is deleted. The object 100′ in image 610′ is positioned according to the disparity required between the images 610′ and 605′. As the active area 620 is smaller than the image 610′, an additional area 620′ is provided in image 610′. The size of additional area 620′ is equal to the size of the deleted non-active area. The active area is then magnified to fill the image 610′. This means that the image 610′ is filled by the correctly positioned object 100′. Similarly, in image 605′, the active area 615 is shown. After the boundary is defined, the non-active area is deleted. The object 100″ in image 605′ is positioned according to the disparity required between the images 610′ and 605′. As the active area 615 is smaller than the image 615′, an additional area 615′ is provided in image 605′. The size of additional area 615′ is equal to the size of the deleted non-active area. The active area is then magnified to fill the image 605′. This means that the image 605′ is filled by the correctly positioned object 100″.

FIG. 7 shows a further embodiment of the present invention. In this embodiment, a camera system 700 is shown. The left camera 730 and the right camera 710 are set up in a parallel arrangement as in FIGS. 3-6 and contain similar features to those explained in respect of FIGS. 3-6. The cameras are focussed to capture an image of object 740. The left camera 730 and the right camera 710 are connected to a processor 720. This processor 720 may or may not be the same as the processors described in the other embodiments. As can be seen from FIG. 7, the left camera 730 is connected to the processor 720 using connection 755, 765 and the right camera 710 is also connected to the processor 720 using connection 750, 760. These connections are bi-directional and may be wired or wireless. In other words, the cameras send images to the processor 720 and the processor 720 send commands to one or both of the cameras. As will be explained with reference to FIG. 8, the commands that are sent from the processor 720 instruct the respective camera to adjust the position of the image with respect to the image capture device within the camera. In other words, the processor 720 instructs the respective camera to adjust the relative position of the image so that the correct disparity can be achieved.

FIG. 8 shows a graphical user interface 800 for operation of the processor 720. In the graphical user interface 800, the image 815 captured by the left camera and the image captured by the right camera 810 is displayed. This allows an operator to view the images captured by the respective cameras. Below each image are two numerical displays. Under image 815 is a left vertical position indicator 825 and under image 810 is a right vertical position indicator 820. These indicators identify the amount of displacement from the initial set-up position the respective cameras have been moved. These values can be changed using either the up or down arrow on the indicator or by typing in a new value in the indicator. The sign of the indicator indicates whether the displacement is up or down relative to the optical axis of the camera. A positive value indicates up relative to the optical axis and a negative value indicates down relative to the optical axis.

Under the left vertical position indicator 825 is the left horizontal position indicator 835 and under the right vertical position indicator 820 is the right horizontal position indicator 830. The left and right horizontal position indicator indicates the amount of displacement from the initial set-up position applied to the left and right camera. Again, these values can be changed using either the up or down arrow on the indicator or by typing in a new value in the indicator. The sign of the indicator indicates whether the displacement is to the left or right of the optical axis of the camera. A positive value indicates to the left of the optical axis and a negative value indicates to the right of the optical axis.

Additionally provided are an overall horizontal position indicator 840 and an overall vertical position indicator 845. These again can be set by the user using either the appropriate arrow or by typing in a value. These can be set by the user to ensure that an appropriate level of disparity between the two cameras in any direction is maintained. In other words, if the user sets an overall horizontal position value, if the user changes the position of the left camera, then the value of the right camera would automatically change to ensure that the overall horizontal position value remains constant. The sign of the disparity follows the same nomenclature as the vertical and horizontal position indicators.

It is envisaged that in embodiments of the present invention, the method may be performed on a computer processor. In this case, the invention may be embodied as a computer program containing computer readable instructions, which, when loaded onto a computer, configure the computer to perform the method according to embodiments. Also, the computer program may be embodied on a storage medium such as a magnetic or optical readable medium. Also, the program may be embodied as a signal which may be used on a network such as a Wireless Local Area Network, the Internet or any type of network.

Also, although FIGS. 7 and 8 describes the cameras as being passive devices (i.e. they are only adjusted in response to a command from a processor), the invention is not so limited. It is envisaged that one camera can output data indicating the amount of adjustment that has been applied thereto to the processor. This data may include data indicating the amount by which the horizontal disparity has been changed by the user. In this case, the processor will update the values in the horizontal and vertical position indicator appropriately.

I claim:

1. A camera device for capturing the image of an object, the camera device comprising: a lens arrangement for focusing the image of the object onto an image capture device for capturing the image of the object; and a movable element operable to move the focussed light relative to the image capture device in one direction, wherein the amount by which the element is movable is determined by the amount of adjustment required to the position of the image on the image capture device in said direction, wherein the lens arrangement comprises at least one lens having an image circle whose size is dependent upon the maximum displacement of the movable element in said one direction.

2. A camera device according to claim 1 wherein the movable element is a further movable lens forming part of the lens arrangement or is operable to move the image capture device.

3. A camera device according to claim 1, wherein the direction is the horizontal direction.

4. A camera arrangement comprising two camera devices according to claim 1 having parallel optical axes and being separated by a predetermined amount.

5. A camera arrangement according to claim 4, wherein the movable lens is configured to adjust the optical path of the light such that when the images captured by the respective camera devices are viewed stereoscopically, the disparity between the viewed objects is a predetermined distance.

6. A camera system comprising a camera arrangement according to claim 4 connectable to a processing device, wherein the processing device is operable to adjust the position of the one or both captured images relative to one another.

7. A camera system according to claim 6, wherein when the position of both captured images is adjusted, the processing device is operable to adjust the position of both images in synchronism with one another.

8. A camera arrangement comprising two camera devices having parallel optical axes and being separated by a predetermined amount, whereby each camera device is configured to capture the image of an object, and comprises: a lens arrangement for focusing the image of the object onto an image capture device for capturing the image of the object; and an anamorphic lens located within the optical axis of the camera device, wherein the amount of anamorphisation provided by the anamorphic lens in one direction is determined in accordance with the amount of adjustment required to the position of the image on the image capture device in said direction, wherein the direction is the horizontal direction.

9. A camera system comprising a camera arrangement according to claim 8 connectable to a processor, wherein the processor is operable to adjust the position of the object such that when the images captured by the respective camera devices are viewed stereoscopically, the disparity between the viewed objects is a predetermined distance.

10. A camera system according to claim 9, wherein the processor is further operable to expand the anamorphised captured image in said direction.

11. A camera system comprising a first camera device and a second camera device having parallel optical axes and being separated by a predetermined amount and a processing device, wherein the processing device is operable to extract an area from within each captured image, the area comprising the object and a surround, wherein the area in each captured image is selected such that when both areas are stereoscopically viewed, the disparity between the two objects in the areas is a predetermined amount, wherein the processing device is further operable to expand the extracted area to the size of the original captured image.

12. A camera device according to claim 1 comprising an output terminal operable to output the amount of movement of the element to a further device.

13. A method for capturing the image of an object, the method comprising: providing a lens arrangement for focusing the image of the object onto an image capture device for capturing the image of the object; and moving the focussed light relative to the image capture device in one direction, wherein the amount by which the element is movable is determined by the amount of adjustment required to the position of the image on the image capture device in said direction, wherein the lens arrangement comprises at least one lens having an image circle whose size is dependent upon the maximum displacement of the movable element in said one direction.

14. A method according to claim 13 wherein either a lens forming part of the lens arrangement or the image capture device is movable.

15. A method according to claim 13, wherein the direction is the horizontal direction.

16. A method according to claim 13 comprising capturing two images having parallel optical axes and separating said images by a predetermined amount.

17. A method according to claim 16, comprising adjusting the optical path of the light such that when the captured images are viewed stereoscopically, the disparity between the viewed objects is a predetermined distance.

18. A method according to claim 16 comprising adjusting the position of the one or both captured images relative to one another.

19. A method according to claim 18, comprising adjusting the position of both images in synchronism with one another.

20. A method for capturing the image of an object, comprising: providing a lens arrangement for focusing the image of the object onto an image capture device for capturing the image of the object; and an anamorphic lens located within the optical axis of the camera device, wherein the amount of anamorphisation provided by the anamorphic lens in one direction is determined in accordance with the amount of adjustment required to the position of the image on the image capture device in said direction, wherein the direction is the horizontal direction and the method comprises capturing two images of the object, the images having parallel optical axes and being separated by a predetermined amount.

21. A method according to claim 20 comprising adjusting the position of the object such that when the images are viewed stereoscopically, the disparity between the viewed objects is a predetermined distance.

22. A method according to claim 21, comprising expanding the anamorphised captured image in said direction.

23. A method according to claim 21, comprising extract an area from within each captured image, the area comprising the object and a surround, wherein the area in each captured image is selected such that when both areas are stereoscopically viewed, the disparity between the two objects in the areas is a predetermined amount.

24. A method according to claim 23, comprising expanding the extracted area to the size of the original captured image.

25. A computer program containing computer readable instructions which, when loaded onto a computer, configure the computer to perform a method according to either one of claims 13 or 20.

26. A computer readable storage medium configured to store the computer program of claim 25 therein or thereon.
